(19) United States
(12) Patent Application Publication
(10) Pub. No.: US 2017/0171884 A1
(43) Pub. Date: Jun. 15, 2017

(54) METHODS AND APPARATUS FOR CONFIGURING LOW-POWER TIME ALLOCATIONS OF A BEACON PERIOD IN A WIRELESS COMMUNICATION NETWORK

(71) Applicants: Huaning NIU, Milpitas, CA (US); Rongzhen YANG, Shanghai (CN); Hujun YIN, Saratoga, CA (US); Qinghua LI, San Ramon, CA (US); Honggang LI, Beijing (CN); Intel Corporation, Santa Clara, CA (US)

(72) Inventors: Huaning NIU, Milpitas, CA (US); Rongzhen YANG, Shanghai (CN); Hujun YIN, Saratoga, CA (US); Qinghua LI, San Ramon, CA (US); Honggang LI, Beijing (CN)

(21) Appl. No.: 15/115,973

(22) PCT Filed: Mar. 11, 2014
(86) PCT No.: PCT/CN2014/073191

§ 371 Date: Aug. 2, 2016

(51) Int. Cl. H04W 74/00; H04W 52/02; H04W 74/08

(52) U.S. Cl. CPC H04W 74/006; H04W 74/085; H04W 52/0216; H04W 84/12

(57) ABSTRACT

Embodiments of a high-efficiency WLAN (HEW) access point (AP), user device (STA), and methods for communication between HEW APs and STAs in a wireless network are generally described herein. In some embodiments, a HEW AP determines a duration of a low-power time allocation, within a beacon period, that is to be reserved for low-power transmissions by STAs within a service range of the AP. The HEW AP can broadcast time sharing information to STAs within the service range of the AP. The time sharing information can indicate a start time of the duration of the low-power time allocation with respect to a start time of the beacon period and a maximum transmission power for transmissions performed during the low-power time allocation. Other embodiments and methods are also described.

### TECHNICAL FIELD

Embodiments pertain to wireless networks. Some embodiments relate to Wi-Fi networks and networks operating in accordance with one of the IEEE 802.11 standards. Some embodiments relate to high-efficiency wireless or high-efficiency WLAN (HEW) communications.

### BACKGROUND

A recently-formed study group for Wi-Fi evolution referred to as the IEEE 802.11 High Efficiency WLAN (HEW) study group (SG) is addressing high-density deployment scenarios. HEWs may provide increased throughput in public locations such as airports and shopping malls in which high-density wireless access points (APs) serve overlapping service areas and in which user devices communicate using peer-to-peer communication mechanisms. However, levels of interference may be high under these scenarios, leading to deterioration in user quality of service. There are also general needs to ensure coexistence between legacy devices and devices suitable for HEW communications.

### BRIEF DESCRIPTION OF THE DRAWINGS

FIG. 1 illustrates a High Efficiency WLAN (HEW) network in accordance with some embodiments;

FIG. 2 is a flow chart of a method for time allocation in a beacon period in accordance with some embodiments;

FIG. 3 illustrates time allocations in a beacon period in accordance with some embodiments;

FIG. 4 is a flow chart of a method for operating according to a time allocation in accordance with some embodiments; and

FIG. 5 illustrates a HEW device in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

A recently-formed study group for Wi-Fi evolution referred to as the Institute of Electrical and Electronics Engineers (IEEE) 802.11 High Efficiency WLAN (HEW) study group (SG), is studying enhancements for system efficiency in high-density wireless communication scenarios.

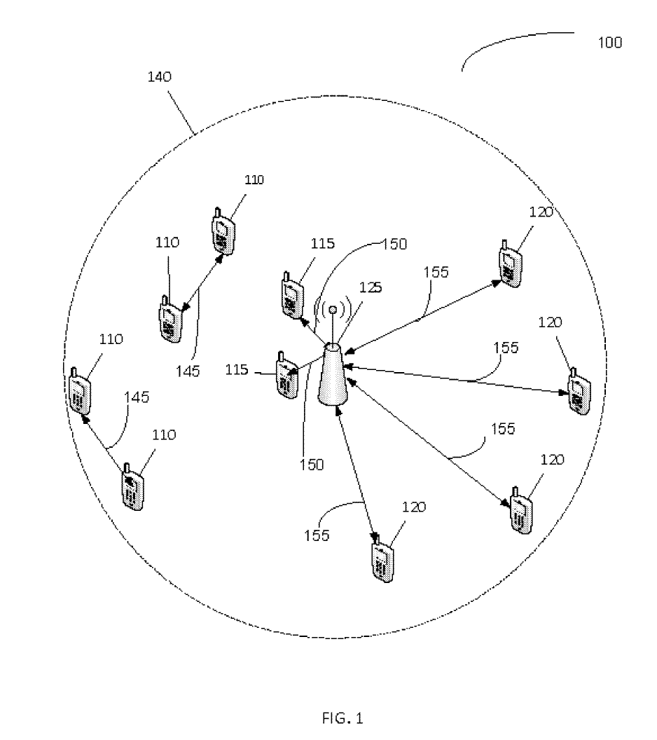

FIG. 1 illustrates a HEW network 100 in accordance with some embodiments. HEW network 100 includes HEW-compliant user wireless communication stations (STAs) 110, which may be in peer-to-peer communication with each other. HEW-compliant STAs 115 and 120 may have a wireless connection through a STA 125. The STA 125 may be a more stationary communication unit such as a wireless access point (AP) and will hereinafter be referred to as the HEW AP 125. At least some STAs 110, 115 and 120 can support HEW while other STAs 110, 115 and 120 may not support HEW. The STAs 110, 115 and 120 may be, for example, laptop computers, smart phones, tablet computers, printers, machine-type devices such as smart meters, or any other wireless device with or without a user interface.

The STAs 110, 115 and 120 can be within a range or service area 140 of the HEW AP 125. The service area 140 can overlap or neighbor service areas (not shown in FIG. 1) of other HEW APs (not shown in FIG. 1). In some usage scenarios of HEW, wireless office and high density access points (APs) with high density user stations (STAs) are supported. In some embodiments, the STAs 110, 115 and 120 and the HEW AP 125 can transmit and receive communications in accordance with specific communication standards, such as the IEEE 802.11 standards, although STAs 110, 115 and 120 and the HEW AP 125 may also be suitable to transmit and receive communications in accordance with other techniques.

HEW AP 125 coverage can be overlaid with device-to-device (D2D) communications. For example, STAs 110 can communicate over links 145 with each other. As bandwidth is increased and HEW AP coverages become denser, co-channel interference becomes a limiting factor such that performance cannot be further improved while maintaining acceptable levels of quality of service. Currently-available channel configuration and selection algorithms for orthogonal channelization may not be adequate in highly-dense use scenarios. This situation is further deteriorated because dynamic frequency selection (DFS) requirements in portions of the 5 GHz band require D2D communications to share channels with the HEW AP 125.

Various embodiments, therefore, provide mechanisms for co-channel D2D and STA-AP operations in HEW use scenarios to reduce or eliminate interference while maintaining backward compatibility with STAs or other devices that may not support HEW.

A low-power communication uses a lower transmit power than a high-power transmission, and a high-power transmission uses a higher transmit power than a low-power transmission. In some embodiments, D2D communications can often be characterized as low-power communications, and STA-AP operations can often be characterized as high-power communications. However, embodiments are not limited thereto. For example, some STAs 115 that are relatively close to HEW AP 125 may utilize low-power communications over low-power links 150 while STAs 120, which may be further from HEW AP 125, may utilize high-power communications over high-power links 155.

In various embodiments, high-power transmissions are separated in time from low-power transmissions, such that high-power transmissions do not interfere with low-power transmissions, and so that low-power transmissions can achieve higher spatial reuse. HEW APs within an area, for example HEW APs whose service areas neighbor each other or overlap, may be synchronized for beacon broadcasting in some examples. Such synchronization may be achieved through use of an access point controller (AC) in managed network, or through neighbor awareness networking (NAN) beacon synchronization protocols. Some embodiments provide for HEW APs to schedule and protect low power transmissions by providing time sharing beacon periods with other, high power transmissions. Some embodiments therefore may exhibit higher throughput due to the increased spatial reuse of multiple, parallel, low power links.

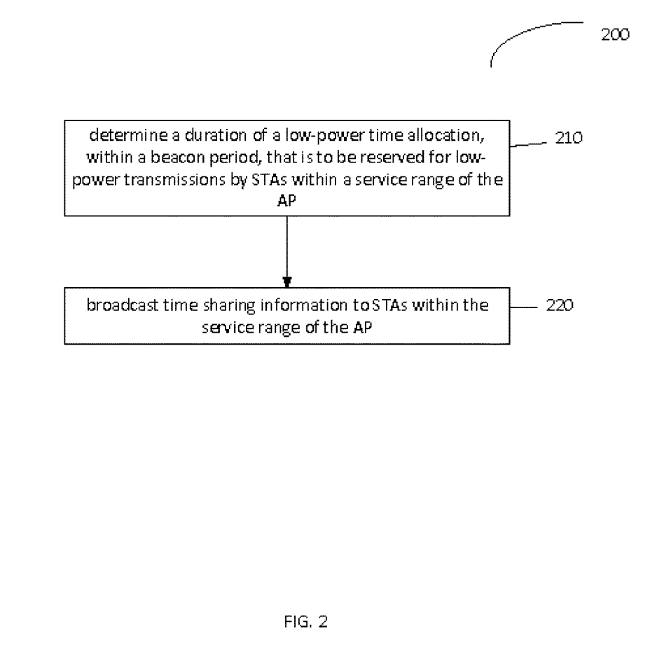

FIG. 2 is a flow chart of a method 200 for time allocation in a beacon period in accordance with some embodiments. The method 200 can be implemented by, for example, a HEW AP 125 (FIG. 1).

In operation 210, HEW AP 125 determines a duration of a low-power time allocation, within a beacon period, that is to be reserved for low-power transmissions by user stations (STAs) within a service range of the HEW AP.

In operation 220, HEW AP 125 broadcasts time sharing information to STAs 110, 115, 120 (FIG. 1) in an area served by the AP. The time sharing information indicates a start time of the duration of the low-power time allocation with respect to a start time of the beacon period and a maximum transmission power for transmissions performed during the low-power time allocation.

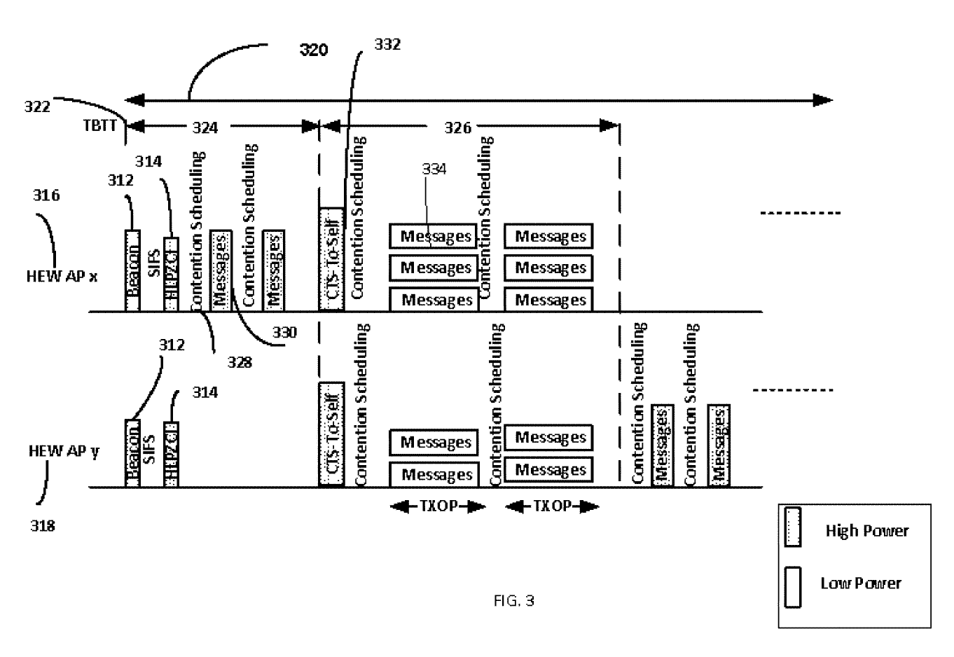

Referring to FIG. 3, which illustrates time allocations 324, 326 in a beacon period 320 in accordance with some embodiments, HEW AP 316 may transmit the time sharing information in a beacon signal 312, or in a high/low power zone configuration information (HLPZCI) message 314 to all HEW-compliant STAs or other STAs (not shown in FIG. 3) within a service area of HEW AP 316. In embodiments for which HEW AP 316 transmits a separate HLPZCI message 314, the HLPZCI message 314 may be transmitted a short interframe space (SIFS) after the termination of the beacon signal 312. The HEW AP 316 is responsible for time allocation configuration in some embodiments because (1) HEW AP 316 has knowledge of the number of D2D pairs within each coverage area, and the statistics and traffic information related to those D2D pairs; (2) HEW AP 316 can control the spatial reuse number statistically by adjusting the maximum transmit power for D2D; and (3) HEW AP 316 is often mounted physically higher than mobile stations and therefore can cover a wider area than mobile stations.

Time allocation according to some embodiments may establish at least two time allocations including at least one high power time allocation 324 and at least one low-power time allocation 326. By allocating separate time allocations for different power levels, interference may be reduced or eliminated and backward compatibility may be maintained based on the interference reciprocity in currently available Wi-Fi systems that use a carrier sense multiple access (CSMA) mechanism. For example, in some available systems if a STA receives a signal from a transmitter with a power level P, the STA expects that the STA would cause an interference of level P at the transmitter if the STA transmits with the same power. Some embodiments can maintain backward compatibility with currently available Wi-Fi systems by maintaining interference reciprocity by grouping the transmissions with the same power into one time allocation.

The time sharing information includes the power levels and the specifications of the corresponding time intervals for those power levels. There can be multiple low power intervals 326 and high-power intervals 324 within one beacon period 320 in some embodiments, to ensure that delay-sensitive traffic gets channel access in both high-power time allocations and low power time allocations.

The duration of time allocations can be determined by an upper layer in some embodiments, for example by a layer above the media access control (MAC) layer. In some embodiments including a managed WiFi network, an AC or other management system may configure the duration of the low-power time allocation 326. For example, the AC or other management system can configure the percentage of the beacon period 320 to be reserved for low power time allocations 326.

In some embodiments that include an un-managed network, the low power allocation 326 may be initiated and configured by a HEW AP 316 and other HEW APs 318 can perform substantially similar low power allocations. In at least these embodiments, a HEW AP 316 can configure a low power allocation 326 in a beacon signal 312 transmission, and neighboring HEW APs 318 can receive that beacon 312 from HEW AP 316. Neighboring HEW APs 318 can use the configuration information in the beacon signal 312 of HEW AP 316 to configure low power allocations 326 at the same time interval with the same power.

The duration of low power time allocations 326 can depend on factors such as the traffic load, and fairness considerations with respect to legacy devices. The HEW AP 316 may vary the duration of low power time allocations in subsequent beacon periods 320 to adapt to traffic needs and other constraints.

HEW APs 316, 318 may synchronize the starting point of a beacon period 320, for example. Synchronization information can be received through an AC or following the synchronization protocol defined in the NAN. Using this synchronization information, HEW APs 316, 318 will synchronize beacon periods 320 such that the high power zone and low power zone configured in different beacons of different HEW APs 316, 318 overlap in time. In embodiments for which HLPZCI is transmitted as a separate message, the HEW AP 125 can synchronize broadcasting of time sharing information with neighboring HEW APs to broadcast the time sharing information concurrently with corresponding broadcasts of time sharing information by neighboring HEW APs. In some embodiments, HEW APs in a network will synchronize the start time of low- or high-power time allocations to maintain interference reciprocity.

In some embodiments, HEW APs may contend for channel resources to send beacon signals and accordingly beacon signals may be sent at different times. However, the starting time of each time allocation will be with respect to the termination of the beacon signal or other configuration packet (e.g., HLPZCI) that includes the corresponding time allocation information. As an illustrative example, HEW AP 125 may transmit a beacon signal indicating that a low power time allocation starts in 30 milliseconds (ms) and lasts for 3 ms. A HEW AP, that neighbors HEW AP 125 and can hear beacon signals transmitted by HEW AP 125, can align the start time of high-power time allocations, low-power time allocations, etc. for STAs within a service range of the corresponding HEW AP, according to the broadcast time or associated termination time of the HEW AP 125 beacon.

HEW APs may often transmit beacons in a full- or high-power mode, and accordingly it may be advantageous in some embodiments, for HEW AP 125, or other HEW APs, to schedule a high-power time allocation immediately after termination of the beacon signal 312 to allow for a margin between the beacon signal 312 and low-power time allocations 326 to eliminate high-power interference with low-power signals. Further, a HEW AP 125 may schedule the start time of the low-power time allocation 326 to occur after a high-power time allocation 324 within the beacon period 320.

In some embodiments, after transmission of time allocation information in either the beacon 312 or the HLPZCI 314, STAs 110, 115 120 may contend for access to the wireless medium during a subsequent contention period 328 in accordance with a collision avoidance or collision detection technique. In some embodiments, HEW-compliant STAs 110, 115, 120, and other, legacy STAs, may contend for channel access (during contention periods 328) in accordance with a carrier sense multiple access with collision avoidance (CSMA/CA) protocol. After contention periods 328, STAs 110, 115, 120 or other, legacy STAs, can perform high-power messaging 330. Subsequent contention scheduling and high-power messaging can occur. However, embodiments are not limited to any particular number of instances of contention scheduling or high-power messaging during high-power transmission allocation 324. STAs within a service range of one or more neighboring HEW APs 318 can refrain from high-power transmissions while high-power transmissions are being performed by STAs within a service area of HEW AP 316.

In some embodiments, protection packets, e.g., clear-to-send (CTS)-to self packets 332, may be transmitted to prevent full-power transmissions, transmitted by legacy devices, from interfering with the low power transmissions. The CTS-to-self packet 332 will be recognizable by legacy STAs that may not otherwise be configured to understand or decode low-power configuration messages, and the CTS-to-self packet 332 will reserve the channel for low-power transmissions by preventing legacy STAs from transmitting.

The CTS-to-self packet 332 will be recognizable by HEW-compatible STAs (e.g., STAs 110, 115, 120, FIG. 1) such that HEW-compatible STAs 110, 115, 120 can recognize that they should contend for the channel with a reduced power level, should the STAs wish to transmit on the channel, upon receiving the CTS-to-self packet. In some embodiments, the CTS-to-self packet is differentiated from currently-used CTS messages by definition of a specific receiver address (RA), of a set of reserved RAs, in the CTS packet. In currently-available systems, the RA field includes the address of a receiving STA. In contrast, in some embodiments, the RA field can also include one of a set of reserved addresses, different from addresses of associated STAs. Multiple RA addresses can be defined in accordance with a standard of an IEEE 802.11 family of standards, for example, an IEEE 802.11 standard for HEW usage scenarios. Each of these reserved RA addresses can represent different maximum transmission power. For example, if four addresses RA1, RA2, RA3 and RA4 are defined in an IEEE 802.11 standard for HEW as reserved for usage in accordance with some embodiments, RA1 can represent 0 dBm maximum transmission power, RA2 can represent 3 dBm maximum transmission power, RA3 can represent 9 dBm maximum transmission power, and RA4 can represent 12 dBm transmission power. However, embodiments are not limited to any number of reserved addresses or maximum power levels.

Using this example, if a HEW AP 316 is to set a maximum transmission power of 0 dBm, an example CTS frame can include the following elements to be interpreted as a CTS-to-self message by HEW-compliant STAs:

TABLE 1
Example CTS frame.

| Octet | Field |
|---|---|
| 2 | Frame Control |
| 2 | Duration |
| 6 | RA1 |
| 4 | FCS |

When a HEW-compatible STA sees or receives this specific RA1, or another RA reserve for usage in accordance with some embodiments, the HEW-compatible STA will start contention in low-power mode with a maximum transmission power of 0 dBm.

In some embodiments, the CTS-to-self packet will be sent shortly (e.g., 0-1 millisecond) before a starting point of a low-power time allocation. The low-power zone will start after the specific CTS-to-self packet is received. HEW-compatible STAs will start contention after passage of a distributed coordination function (DCF) interframe space (DIFS) time with a clear channel. In other embodiments for which HEW-compliant STAs 110, 115, 120 are also transmitting high-power traffic, HEW AP 125 may transmit the CTS-to-self packet such that there is a larger gap between termination of the CTS-to-self packet and the start of the low-power time allocation. The CTS-to-self packet can include a duration field indicating a value equal to or greater than the duration of the low-power time allocation.

The CTS-to-self can include a duration value to specify a duration long enough to cover the termination of the low power allocation. For lowering the overhead, only AP may send the protection CTS-to-self packet and mobile stations may rely on the protection coverage made by the AP.

In some embodiments, HEW AP 125 can configure other parameters in addition to transmission power. Such parameters can include, for example, channel and congestion aware (CCA) levels. A HEW-compliant STA 110, 115, 120 may include a timer for tracking or timing the termination time of each time allocation and for keeping track of the remaining time in a given time allocation. In some embodiments, a HEW-compliant STA 110, 115, 120 may perform packet fragmentation in the event that timers indicate that a packet cannot be sent during a particular time allocation.

Various embodiments are described with reference to FIG. 3 with respect to two HEW APs 316 and 318. Either or both of HEW APs 316 and 318 may operate to serve as HEW AP 125 (FIG. 1). HEW APs 316 and 318 may serve service areas that neighbor or overlap each other, either partially or completely, although embodiments are not limited thereto. While signaling of two HEW APs 316 and 318 is discussed with respect to FIG. 3, it will be understood that any number of HEW APs, with service areas neighboring or overlapping service areas of HEW APs 316 and 318, may perform at least somewhat similar signaling. While only one beacon period 320 is shown, the same or similar allocations can occur in subsequent beacon periods.

The HEW APs 316 and 318 will synchronize broadcasting of time sharing information with each other, such that the HEW APs 316 and 318 broadcast time sharing information concurrently. In some embodiments, HEW APs 316 and 318 may synchronize beacon signal 312 transmission, such that HEW APs 316 and 318 both transmit beacon signal 312 at a target beacon transmission time (TBTT) 322. In at least those embodiments, time sharing information transmitted in those beacon signals 312 will accordingly be synchronized. In some embodiments for which HEW APs 316 and 318 transmit time sharing information in a HLPZI message, the HLPZI messages may be synchronized by virtue of being separated by an SIFS from corresponding transmission of synchronized beacon signals 312.

Further, in some embodiments, HEW APs 316 and 318 may synchronize the start time of low-power time allocation by detecting signals, broadcast by the other of HEW AP 316, 318 to determine a start time of the low-power time allocation for STAs within a service range of the other HEW AP 316 or 318. IN other embodiments, HEW APs 316 and 318 receive synchronizing information from an overlapping basic service set (BSS) to synchronize broadcasting of time sharing information with each other.

At some point subsequent to broadcasting the time sharing information and at a starting point of the low-power time allocation, HEW APs 316 and 318 transmits a clear-to-send (CTS)-to-self message. A duration field of the CTS-to-self message can indicate a value equal to or greater than the duration of the low-power time allocation. The CTS-to-self message may include a receiver address (RA) field as described above to represent a different maximum transmit power.

HEW APs 316 and 318 may schedule the start of time of a low-power allocation 326 to occur after a high-power time allocation 324 within the beacon period 320, where the high-power time allocation 324 is reserved for high-power transmissions by STAs (not shown in FIG. 3) within the service range of the corresponding HEW AP 316 or 318.

STAs can perform same or similar contention scheduling, subsequent to the CTS-to-self transmission 332, and thereafter perform low-power transmissions 334. Other STAs served by HEW AP 318 or other neighboring HEW APs (not shown in FIG. 3) can concurrently perform low-power transmissions without interfering with low-power transmissions of STAs served by HEW AP 316. STAs can transmit ready-to-send (RTS) or CTS messages at the start of low-power transmissions 334. The RTS or CTS transmission power can be smaller than the maximum power configured in the CTS-to-self 332 or HLPZCI 314.

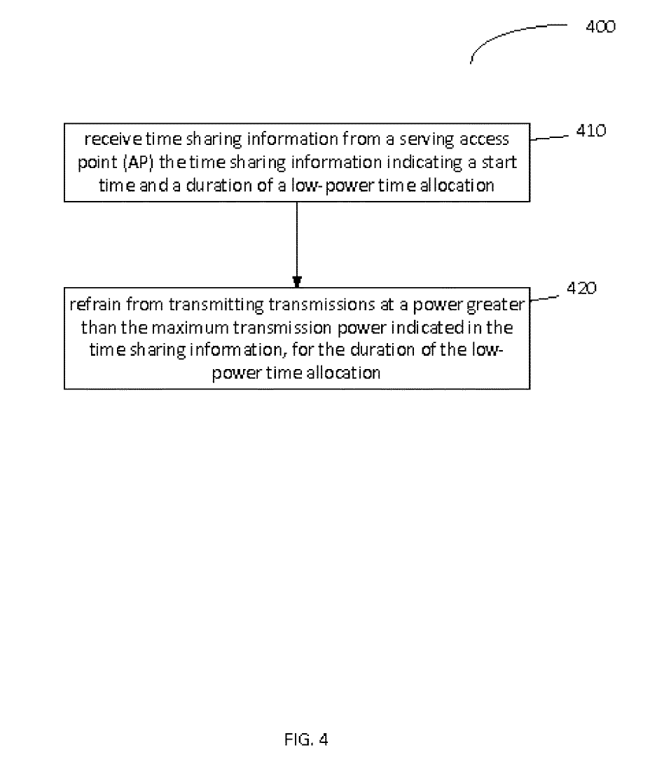

FIG. 4 is a flow chart of a method 400 for operating according to a time allocation in accordance with some embodiments. The method 400 can be implemented by, for example, a HEW-compliant STA 110 (FIG. 1).

In operation 410, STA 110 receives time sharing information from a serving access point (AP), for example HEW AP 125 (FIG. 1). As described above regarding FIG. 2 and FIG. 3, the time sharing information can indicate a start time and a duration of a low-power time allocation during which the STA 110 is to refrain from transmitting high-power transmissions. The time sharing information can further include information regarding a maximum transmission power allowed for the duration of the low-power time allocation.

In operation 420, STA 110 refrains from transmitting transmissions at a power greater than the maximum transmission power indicated in the time sharing information, for the duration of the low-power time allocation. As described above with respect to FIG. 3, STA 110 will transmit low-power transmissions during the low-power time duration. STA 110 may begin by transmitting a low-power RTS message at a start point of the low-power time allocation 326 (FIG. 3). The STA 110 can transmit the RTS to a second STA in communication with the STA 110. The second STA can be indicated in the RA field of the RTS, and the second STA can transmit a low power clear-to-send (CTS) to indicate that STA 110 may begin low-power transmissions. STA 110 can initiate low-power transmissions, with a power at or below the maximum transmission power allowed, subsequent to receiving the CTS message from the second STA. In some embodiments, STA 110 can also start low power transmission without the RTS/CTS handshake.

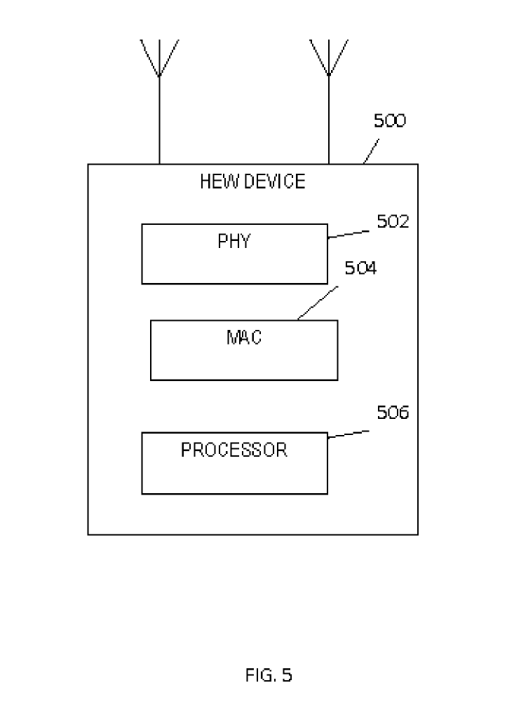

FIG. 5 illustrates a HEW device in accordance with some embodiments. HEW device 500 may be an HEW compliant device that may be arranged to communicate with one or more other HEW devices, such as HEW devices as well as communicate with legacy devices. HEW device 500 may be suitable for operating as a HEW AP 125 (FIG. 1) or a HEW STA 110, 115, 120 (FIG. 1). In accordance with embodiments, HEW device 500 may include, among other things, physical layer (PHY) 502, medium-access control layer (MAC) 504 and one or more processors 506. PHY 502 and MAC 504 may be HEW compliant layers and may also be compliant with one or more legacy IEEE 802.11 standards. PHY 502 and MAC 504 can be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, PHY 502 or MAC 504 can be implemented or partially implemented in one or a combination of hardware, firmware and software. Embodiments may also be implemented as instructions stored on a computer-readable storage device.

Processor 506 may be arranged to determine a duration of a low-power time allocation 326 (FIG. 3), within a beacon period 320 (FIG. 3), that is to be reserved for low-power transmissions by STAs within a service range of HEW device 500. Processor 506 may determine the duration of the low-power time allocation 326 by detecting a signal, broadcast by a neighboring HEW device, to determine a start time of the low-power time allocation for STAs within a service range of the neighboring HEW device. Processor 506 may synchronize broadcasting of time sharing information with the neighboring HEW device to broadcast the time sharing information concurrently with corresponding broadcasts of time sharing information by the neighboring HEW device. Processor 506 may perform this synchronization by listening to neighboring HEW device beacon signals or by receiving information from an overlapping BSS.

Processor 506 can synchronize the start time of the low-power time allocation 326 for STAs within a service range of the HEW device to occur at substantially a same time as the start time of the low-power time allocation 326 for STAs within the service range of the neighboring HEW device.

PHY 502 may be arranged to broadcast time sharing information to STAs in an area served by the HEW device 500. The time sharing information can indicate a start time of the duration of the low-power time allocation 326 with respect to a start time of the beacon period 320 and a maximum transmission power allowed for the duration.

PHY 502 may transmit, subsequent to broadcasting the time sharing information and at a starting point of the low-power time allocation subsequent to a high-power time allocation for which high-power transmissions is permitted, a clear-to-send (CTS)-to-self 332 (FIG. 3) message. A duration field of the CTS-to-self message can indicate a value equal to or greater than the duration of the low-power time allocation 326. The CTS-to-self 332 message can include a receiver address (RA) field as described herein.

In some embodiments, the HEW device 500 may be configured to communicate using OFDM communication signals over a multicarrier communication channel. In some embodiments, HEW device 500 may be configured to receive signals in accordance with specific communication standards, such as the Institute of Electrical and Electronics Engineers (IEEE) standards including IEEE 802.11-2012 and/or 802.11n-2009 standards and/or proposed specifications for WLANs including proposed HEW standards, although the scope of embodiments is not limited in this respect as they may also be suitable to transmit and/or receive communications in accordance with other techniques and standards. In some other embodiments, HEW device 500 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, HEW device 500 may be part of a portable wireless communication device, such as a personal digital assistant (PDA), a laptop or portable computer with wireless communication capability, a web tablet, a wireless telephone or smartphone, a wireless headset, a pager, an instant messaging device, a digital camera, an access point, a television, a medical device (e.g., a heart rate monitor, a blood pressure monitor, etc.), or other device that may receive and/or transmit information wirelessly. In some embodiments, HEW device 500 may include one or more of a keyboard, a display, a non-volatile memory port, multiple antennas, a graphics processor, an application processor, speakers, and other mobile device elements. The display may be an LCD screen including a touch screen.

The antennas may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result between each of antennas and the antennas of a transmitting station.

Although HEW device 500 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of HEW device 500 may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

In accordance with embodiments, interference by high-power transmissions is reduced or eliminated by limiting high-power transmissions to one portion of a beacon period, and by limiting low-power transmissions to other portions of a beacon period. Backward compatibility is maintained at least because interference reciprocity is maintained in that transmissions occur at same or similar power levels during corresponding time allocations allocated to high or low-power transmissions.

### Additional Notes & Examples

Example 1 includes subject matter (such as a method or means for performing acts) for operating in a wireless communication network, including determining a duration of a low-power time allocation, within a beacon period, that is to be reserved for low-power transmissions by user stations (STAs) within a service range of the access point (AP), and broadcasting time sharing information to STAs within the service range of the AP, the time sharing information indicating a start time of the duration of the low-power time allocation with respect to a start time of the beacon period and a maximum transmission power for transmissions performed during the low-power time allocation.

Example 2 may optionally include the subject matter of Example 1, and further comprising transmitting, subsequent to broadcasting the time sharing information and at a starting point of the low-power time allocation, a clear-to-send (CTS)-to-self message, a duration field of the CTS-to-self message indicating a value equal to or greater than the duration of the low-power time allocation.

Example 3 may optionally include the subject matter of Examples 1-2, wherein the CTS-to-self message includes a receiver address (RA) field, the RA field including a value of a set of reserved values in accordance with a standard of the Institute of Electrical and Electronics Engineers (IEEE) 802.11 family of standards, wherein the value indicates maximum transmit power.

Example 4 may optionally include the subject matter of Examples 1-3, wherein the start time of the low-power time allocation is to occur after reception of the CTS-to-self including the RA field.

Example 5 may optionally include the subject matter of Examples 1-4, wherein the start time of the low-power time allocation is determined by detecting a signal, broadcast by a neighboring AP, to determine a start time of the low-power time allocation for STAs within a service range of the neighboring AP.

Example 6 may optionally include the subject matter of Examples 1-5, further comprising synchronizing broadcasting of time sharing information with the neighboring AP to broadcast the time sharing information concurrently with corresponding broadcasts of time sharing information by the neighboring AP.

Example 7 may optionally include the subject matter of Examples 1-6, further comprising synchronizing the start point of the low-power time allocation such that the start point of the low-power time allocation for the AP occurs at substantially the same time as the start point of the low-power time allocation for the neighboring AP.

Example 8 may optionally include the subject matter of Examples 1-7, further comprising receiving synchronizing information from an overlapping basic service set (BSS) to synchronize broadcasting of time sharing information with the neighboring AP.

Example 9 may optionally include the subject matter of Examples 1-8, further comprising synchronizing the start point of the low-power time allocation such that the start point of the low-power time allocation for the AP occurs at substantially the same time as the start point of the low-power time allocation for the neighboring AP.

Example 10 may optionally include the subject matter of Examples 1-9, wherein the duration is determined based on a management message received from an access point controller (AC).

Example 11 may optionally include the subject matter of Examples 1-10, further comprising scheduling the start time of the duration to occur after a high-power time allocation within the beacon period, the high-power time allocation being reserved for high-power transmissions by STAs within the service range of the AP.

Example 12 may optionally include the subject matter of Examples 1-11, wherein the time sharing information is broadcast in a High and Low Power Zone Configuration Information (HLPZI) message in accordance with a standard of Institute of Electrical and Electronics Engineers (IEEE) 802.11 family of standards.

Example 13 may include subject matter (such as a device, apparatus, wireless communication (STA), client or system) including physical layer (PHY) circuitry to receive time sharing information from a serving access point (AP), the time sharing information indicating a start time and a duration of a low-power time allocation during which the STA is to refrain from transmitting high-power transmissions and a maximum transmission power allowed for the duration of the low-power time allocation and one or more processors to refrain from transmitting transmissions at a power greater than the maximum transmission power indicated in the time sharing information, for the duration of the low-power time allocation.

Example 14 may optionally include the subject matter of Example 13, wherein the PHY circuitry is further arranged to receive a clear-to-send (CTS)-to-self message, the CTS-to-self message including a receiver address (RA) field, the RA field including a value of a set of reserved values in accordance with a standard of the Institute of Electrical and Electronics Engineers (IEEE) 802.11 family of standards, wherein the value represents maximum transmit power.

Example 15 may optionally include the subject matter of Examples 13-14, wherein the PHY circuitry is further arranged to transmit a low-power request to send (RTS) message at a start point of the low-power time allocation, to a second STA in communication with the STA, the second STA being indicated in the RA field, the second STA transmitting a low power clear-to-send (CTS); and initiate low-power transmissions, with a power at or below the maximum transmission power allowed, subsequent to receiving the CTS message.

Example 16 may include subject matter (such as a device, apparatus, access point (AP), client or system) including processing circuitry to determine a duration of a low-power time allocation, within a beacon period, that is to be reserved for low-power transmissions by user stations (STAs) within a service range of the AP; and physical layer (PHY) circuitry to broadcast time sharing information to STAs in an area served by the AP, the time sharing information indicating a start time of the duration of the low-power time allocation with respect to a start time of the beacon period and a maximum transmission power allowed for the duration; and transmit, subsequent to broadcasting the time sharing information and at a starting point of the low-power time allocation subsequent to a high-power time allocation for which high-power transmissions is permitted, a clear-to-send (CTS)-to-self message, a duration field of the CTS-to-self message indicating a value equal to or greater than the duration of the low-power time allocation.

Example 17 may optionally include the subject matter of Example 16, wherein the CTS-to-self message includes a receiver address (RA) field, the RA field including a value defined from a set of reserved values in accordance with a standard of the Institute of Electrical and Electronics Engineers (IEEE) 802.11 family of standards, wherein the value represents maximum transmit power.

Example 18 may optionally include the subject matter of Examples 16-17, wherein the processing circuitry is further arranged to determine the duration of the low-power time allocation by detecting a signal, broadcast by a neighboring AP, to determine a start time of the low-power time allocation for STAs within a service range of the neighboring AP; and synchronize broadcasting of time sharing information with the neighboring AP to broadcast the time sharing information concurrently with corresponding broadcasts of time sharing information by the neighboring AP by listening to neighboring AP beacon signals or by receiving information from an overlapping basic service set (BSS).

Example 19 may optionally include the subject matter of Examples 16-18, wherein the processing circuitry is further arranged to synchronize the start time of the low-power time allocation for STAs within a service range of the AP to occur at substantially a same time as the start time of the low-power time allocation for STAs within the service range of the neighboring AP.

Example 20 may include subject matter (such as a device, apparatus, client or system) including physical layer circuitry; one or more processors arranged to determine a duration of a low-power time allocation, within a beacon period, that is to be reserved for low-power transmissions by user stations (STAs) within a service range of the AP; and one or more antennas coupled to the physical layer circuitry, the physical layer circuitry arranged to broadcast time sharing information to STAs in an area served by the AP, the time sharing information indicating a start time of the duration of the low-power time allocation with respect to a start time of the beacon period and a maximum transmission power allowed for the duration; and transmit, subsequent to broadcasting the time sharing information, a clear-to-send (CTS)-to-self message, a duration field of the CTS-to-self message indicating a value equal to or greater than the duration of the low-power time allocation.

Example 21 may optionally include the subject matter of Examples 20, the one or more processors are further arranged to determine the duration of the low-power time allocation by detecting a signal, broadcast by a neighboring AP, to determine a start time of the low-power time allocation for STAs within a service range of the neighboring AP; and synchronize broadcasting of time sharing information with the neighboring AP to broadcast the time sharing information concurrently with corresponding broadcasts of time sharing information by the neighboring AP by listening to neighboring AP beacon signals or by receiving information from an overlapping basic service set (BSS).

Example 22 may include subject matter (such as means for performing acts or machine readable medium including instructions that, when executed by the machine, cause the machine to perform acts) including receiving time sharing information from a serving access point (AP), the time sharing information indicating a start time and a duration of a low-power time allocation during which the STA is to refrain from transmitting high-power transmissions and a maximum transmission power allowed for the duration of the low-power time allocation; refraining from transmitting transmissions at a power greater than the maximum transmission power indicated in the time sharing information, for the duration of the low-power time allocation; transmitting a clear to send (CTS) message at a start point of the low-power time allocation; and transmitting low-power transmissions, with a power at or below the maximum transmission power allowed, subsequent to transmitting the CTS message.

Example 23 may optionally include the subject matter of Example 22, further comprising instructions to refrain from transmitting low-power transmissions until a clear-to-send (CTS)-to-self message is received from the serving AP to indicate the start point of the low-power time allocation.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1-23. (canceled)

24. A method, performed by an access point (AP), for operating in a wireless communication network, the method comprising:
determining a duration of a low-power time allocation, within a beacon period, that is to be reserved for low-power transmissions by user stations (STAs) within a service range of the AP; and
broadcasting time sharing information to STAs within the service range of the AP, the time sharing information indicating a start time of the duration of the low-power time allocation with respect to a start time of the beacon period and a maximum transmission power for transmissions performed during the low-power time allocation.

25. The method of claim 24, further comprising:
transmitting, subsequent to broadcasting the time sharing information and at a starting point of the low-power time allocation, a clear-to-send (CTS)-to-self message, a duration field of the CTS-to-self message indicating a value equal to or greater than the duration of the low-power time allocation.

26. The method of claim 24, wherein the CTS-to-self message includes a receiver address (RA) field, the RA field including a value of a set of reserved values in accordance with a standard of the Institute of Electrical and Electronics Engineers (IEEE) 802.11 family of standards, wherein the value indicates maximum transmit power.

27. The method of claim 26, wherein the start time of the low-power time allocation is to occur after reception of the CTS-to-self including the RA field.

28. The method of claim 24, wherein the start time of the low-power time allocation is determined by detecting a signal, broadcast by a neighboring AP, to determine a start time of the low-power time allocation for STAs within a service range of the neighboring AP.

29. The method of claim 28, further comprising:
synchronizing broadcasting of time sharing information with the neighboring AP to broadcast the time sharing information concurrently with corresponding broadcasts of time sharing information by the neighboring AP.

30. The method of claim 29, further comprising:
synchronizing the start point of the low-power time allocation such that the start point of the low-power time allocation for the AP occurs at substantially the same time as the start point of the low-power time allocation for the neighboring AP.

31. The method of claim 28, further comprising receiving synchronizing information from an overlapping basic service set (BSS) to synchronize broadcasting of time sharing information with the neighboring AP.

32. The method of claim 31, further comprising:
synchronizing the start point of the low-power time allocation such that the start point of the low-power time allocation for the AP occurs at substantially the same time as the start point of the low-power time allocation for the neighboring AP.

33. The method of claim 24, wherein the duration is determined based on a management message received from an access point controller (AC).

34. The method of claim 24, further comprising:
scheduling the start time of the duration to occur after a high-power time allocation within the beacon period, the high-power time allocation being reserved for high-power transmissions by STAs within the service range of the AP.

35. The method of claim 24, wherein the time sharing information is broadcast in a High and Low Power Zone Configuration Information (HLPZI) message in accordance with a standard of Institute of Electrical and Electronics Engineers (IEEE) 802.11 family of standards.

36. A wireless communication station (STA), for operating in a wireless communication network, comprising:
physical layer (PHY) circuitry to
receive time sharing information from a serving access point (AP), the time sharing information indicating a start time and a duration of a low-power time allocation during which the STA is to refrain from transmitting high-power transmissions and a maximum transmission power allowed for the duration of the low-power time allocation; and
one or more processors to
refrain from transmitting transmissions at a power greater than the maximum transmission power indicated in the time sharing information, for the duration of the low-power time allocation.

37. The STA of claim 36, wherein the circuitry is further arranged to receive a clear-to-send ((CTS)-to-self message, the CTS-to-self message including a receiver address (RA) field, the RA field including a value of a set of reserved values in accordance with a standard of the Institute of Electrical and Electronics Engineers (IEEE) 802.11 family of standards, wherein the value represents maximum transmit power.

38. The STA of claim 36, wherein the PHY circuitry is further arranged to transmit a low-power request to send (RTS) message at a start point of the low-power time allocation, to a second STA in communication with the STA, the second STA being indicated in the RA field, the second STA transmitting a low power clear-to-send (CTS); and
initiate low-power transmissions, with a power at or below the maximum transmission power allowed, subsequent to receiving the CTS message.

39. An access point (AP) for operating in a wireless communication network, the AP comprising:
processing circuitry to determine a duration of a low-power time allocation, within a beacon period, that is to be reserved for low-power transmissions by user stations (STAs) within a service range of the AP; and
physical layer (PHY) circuitry to
broadcast time sharing information to STAs in an area served by the AP, the time sharing information indicating a start tune of the duration of the low-power time allocation with respect to a start time of the beacon period and a maximum transmission power allowed for the duration, and
transmit, subsequent to broadcasting the time sharing information and at a starting point of the low-power time allocation subsequent to a high-power time allocation for which high-power transmissions is permitted, a clear-to-send (CTS)-to-self message, a duration field of the CTS-to-self message indicating a value equal to or greater than the duration of the low-power time allocation.

40. The AP of claim 39, wherein the CTS-to-self message includes a receiver address (RA) field, the RA field including a value defined from a set of reserved values in accordance with a standard of the Institute of Electrical and Electronics Engineers (IEEE) 802.11 family of standards, wherein the value represents maximum transmit power.

41. The AP of claim 39, wherein the processing circuitry is further arranged to
determine the duration of the low-power time allocation by detecting a signal, broadcast by a neighboring AP, to determine a start time of the low-power time allocation for STAs within a service range of the neighboring AP; and
synchronize broadcasting of time sharing information with the neighboring AP to broadcast the time sharing information concurrently with corresponding broadcasts of time sharing information by the neighboring AP by listening to neighboring AP beacon signals or by receiving information from an overlapping basic service set (BSS).

42. The AP of claim 41, wherein the processing circuitry is further arranged to synchronize the start time of the low-power time allocation for STAs within a service range of the AP to occur at substantially a same time as the start time of the low-power time allocation for STAs within the service range of the neighboring AP.

43. A system comprising:
physical layer circuitry;
one or more processors arranged to determine a duration of a low-power time allocation, within a beacon period, that is to be reserved for low-power transmissions by user stations (STAs) within a service range of an access point (AP); and
one or more antennas coupled to the physical layer circuitry, the physical layer circuitry arranged to
broadcast time sharing information to STAs in an area served by the AP, the time sharing information indicating a start time of the duration of the low-power time allocation with respect to a start time of the beacon period and a maximum transmission power allowed for the duration; and
transmit, subsequent to broadcasting the time sharing information, a clear-to-send (CTS)-to-self message, a duration field of the CTS-to-self message indicating a value equal to or greater than the duration of the low-power time allocation.

44. The system of claim 43, wherein the one or more processors are further arranged to determine the duration of the low-power time allocation by detecting a signal, broadcast by a neighboring AP, to determine a start time of the low-power time allocation for STAs within a service range of the neighboring AP; and
synchronize broadcasting of time sharing information with the neighboring AP to broadcast the time sharing information concurrently with corresponding broadcasts of time sharing information by the neighboring AP by listening to neighboring AP beacon signals or by receiving information from an overlapping basic service set (BSS).

45. A non-transitory computer-readable storage medium that stores instructions for execution by one or more processors to perform operations comprising:
receiving time sharing information from a serving access point (AP), the time sharing information indicating a start time and a duration of a low-power time allocation during which the STA is to refrain from transmitting high-power transmissions and a maximum transmission power allowed for the duration of the low-power time allocation;
refraining from transmitting transmissions at a power greater than the maximum transmission power indicated in the time sharing information, for the duration of the low-power time allocation;
transmitting a clear to send (CTS) message at a start point of the low-power time allocation; and
transmitting low-power transmissions, with a power at or below the maximum transmission power allowed, subsequent to transmitting the CTS message.

46. The non-transitory computer-readable storage medium of claim 45, further comprising instructions to refrain from transmitting low-power transmissions until a clear-to-send (CTS)-to-self message is received from the serving AP to indicate the start point of the low-power time allocation.
